(19) United States
(12) Patent Application Publication
(10) Pub. No.: US 2026/0210725 A1
(43) Pub. Date: Jul. 23, 2026

(54) Design Support Apparatus and Design Support Method

(71) Applicant: Hitachi, Ltd., Tokyo (JP)

(72) Inventors: Teppei SAITO, Tokyo (JP); Hiroto MORIZANE, Tokyo (JP)

(21) Appl. No.: 19/293,058

(22) Filed: Aug. 7, 2025

(30) Foreign Application Priority Data
Oct. 18, 2024 (JP) 2024-182555

(51) Int. Cl. G01C 21/34; G01C 21/36

(52) U.S. Cl. CPC G01C 21/3415; G01C 21/3492; G01C 21/3617

(57) ABSTRACT

Problem: To provide a design support apparatus capable of simulating traffic conditions adaptable to actual circumstances by permitting a behavioral modification in accordance with a user's behavioral purpose.

Solution: Provided is the design support apparatus which includes: a storage unit that stores service plan information and environment information; a behavioral purpose input unit that inputs behavioral purpose information; a new facility information input unit that inputs new facility information; a generation unit that generates a behavioral modification model for modifying a behavior of the user in an area using the environment information and the behavioral purpose information; a first computing unit that computes a first traffic condition indicating the traffic conditions of a service mobile object and the respective users under an environment in which the service mobile object and a new facility exist using the service plan information, the environment information, the new facility information, and the behavioral modification model; and a second computing unit that computes a second traffic condition indicating the traffic conditions of the respective users under an environment in which the service mobile object and the new facility do not exist using the environment information and the behavioral modification model. The first computing unit modifies the user's behavior in accordance with the influence of the new facility, and computes the traffic conditions of the service mobile object and the respective users.

### CLAIM OF PRIORITY

The present application claims priority from Japanese Patent application serial no. 2024-182555, filed on Oct. 18, 2024, the content of which is hereby incorporated by reference into this application.

### TECHNICAL FIELD

The present invention relates to a design support apparatus and a design support method for estimating a traffic condition in an operation service area of a mobility service.

### BACKGROUND ART

In recent years, mobility services such as a demand taxi and a self-driving bus have been increasingly used by residents for transportation in the urban area. In order to increase business earnings of the mobility service, it is necessary to either increase the number of passengers in the service operation area (hereinafter referred to as a “block”), raise the fare, or reduce the operational cost. For example, in the case of the self-driving bus operated as the mobility service, it is especially essential to appropriately design a traveling route that may greatly influence the increase or decrease of the number of passengers.

In the case of excessive service operations along the traveling route designed by the bus operator to the regional condition, the operational cost will be increased to deteriorate the business earnings. In contrast, in the case of insufficient service operations, the block user will suffer inconvenience. This may interfere with the increase in the number of passengers, thus causing the problem of deterioration in the business earnings.

Patent Literature 1 discloses “the block design support apparatus, and the block evaluation support apparatus to attain more comfortable block to users” as a solution of the problem as described above. Specifically, “the block design support apparatus includes: the design model acquisition unit for acquiring the design target block model having the road and the residential area to satisfy the requirement including the site condition; the traffic volume deriving unit for deriving the traffic volume information indicating the traffic volume of mobile objects that travel on the road on the acquired design target block model, including the traveling vehicle having the predetermined service function; and the design model adjustment unit that simulates the traffic condition of the mobile object on the road of the design target block model in accordance with the traffic volume of the mobile object indicated by the derived traffic volume information, and adjusts at least one of the design block condition as the condition relating to the design target block model, and the operation plan of the traveling vehicle so that the simulated model brings more comfortable state to users in the block compared with the design target block model before the simulation”.

### CITATION LIST

### Patent Literature

Patent Literature 1: Japanese Unexamined Patent Application Publication No. 2022-124910

### SUMMARY OF INVENTION

### Technical Problem

The technology disclosed in Patent Literature 1 is employed to simulate the traffic condition under the static condition such as the destination of each user in the respective blocks without considering changeability of the destination of each user depending on the environment. The destination of each user on the simulator of Patent Literature 1, thus, is not changed even under the new environment where the facility that can serve purposes (for example, purchase of specific merchandise items) of the respective users is newly constructed. The presence or absence of the new facility hardly influences the result of simulating the traffic conditions. Actually, the new facility may be a destination candidate for the block user. Accordingly, it is clear that the simulated traffic condition that is not influenced by the new facility as disclosed in Patent Literature 1 has difficulties in adapting to the actual environment after construction of the new facility.

An object of the present invention is to provide a design support apparatus and a design support method, which allow estimation of the traffic condition adaptable to actual circumstances.

### Solution to Problem

To solve the above-described problem, a design support apparatus according to the present invention estimates a traffic condition in an area, and includes: a storage unit that stores service plan information which contains a traveling route for a service mobile object, and environment information that contains an arrangement of a road and an object in the area; a behavioral purpose input unit that inputs a behavioral purpose of a user in the area as behavioral purpose information; a new facility information input unit that inputs a new facility in the area as new facility information; a generation unit that generates a behavioral modification model that modifies a behavior of the user in the area using the environment information and the behavioral purpose information; a first computing unit that computes a first traffic condition indicating the traffic conditions of the service mobile object and the respective users under an environment in which the service mobile object and the new facility exist using the service plan information, the environment information, the new facility information, and the behavioral modification model; a second computing unit that computes a second traffic condition indicating the traffic conditions of the respective users under an environment in which the service mobile object and the new facility do not exist using the environment information and the behavioral modification model; and an output device that outputs the first traffic condition and the second traffic condition. The first computing unit modifies the behavior of the user in accordance with an influence of the new facility, and computes the traffic conditions of the service mobile object and the respective users.

### Advantageous Effects of Invention

The design support apparatus and the design support method according to the present invention allow estimation of the traffic condition adaptable to actual circumstances by permitting the behavioral modification in accordance with the user's behavioral purpose under the condition where the facility that serves the behavioral purpose is newly constructed.

### BRIEF DESCRIPTION OF DRAWINGS

FIG. 1 is a schematic diagram of a design support apparatus according to a first embodiment.

FIG. 2 illustrates an example of a block according to the first embodiment.

FIG. 3 illustrates an example of information to be used for a behavioral modification model according to the first embodiment.

FIG. 4 represents an example of a flowchart indicating operations of a first computing unit according to the first embodiment.

FIG. 5 represents an example of a flowchart indicating operations of a second computing unit according to the first embodiment.

FIG. 6 illustrates an example of a screen displayed by an output device according to the first embodiment.

FIG. 7 illustrates an example of a worksite according to a second embodiment.

### DESCRIPTION OF EMBODIMENTS

The following describes a support operation for designing a traveling route of a self-driving bus (hereinafter referred to as a “service mobile object V”) in an operation area (block) of the mobility service as an example of an embodiment according to the present invention.

The present invention is applicable to the design of general service concerning an autonomously travelable mobile object under the specific environment. The application of the present invention, thus, should not be limited to an automobile. For example, the present invention is applicable to simulation of traffic conditions of autonomously movable objects, for example, transport vehicles, agricultural work vehicles, and construction vehicles.

### First Embodiment

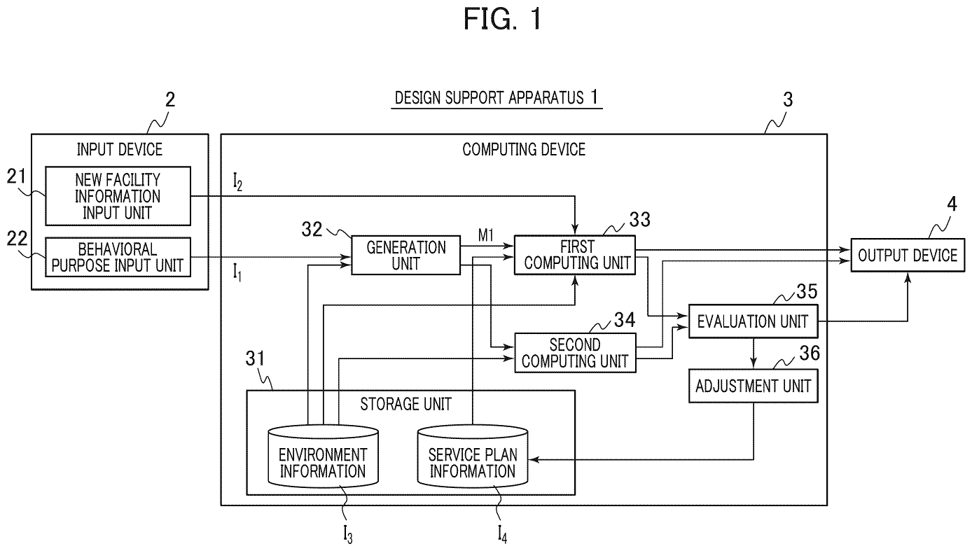

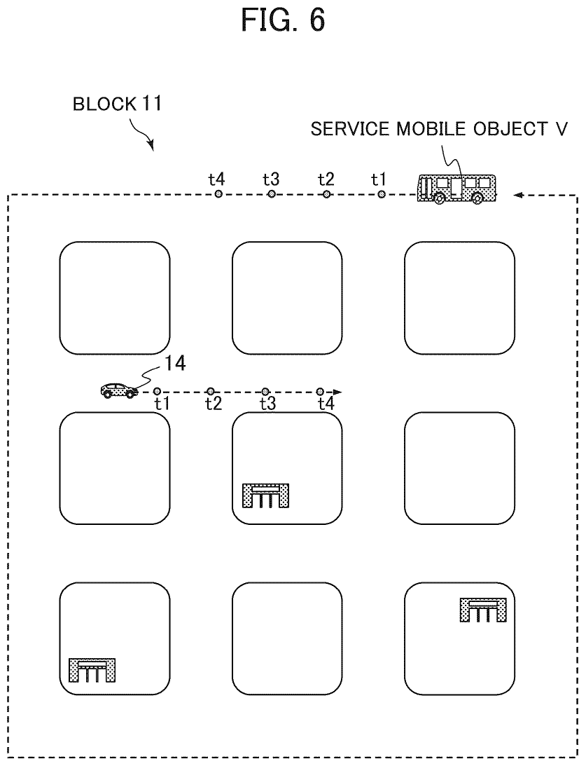

Referring to FIG. 1 to FIG. 6, the following describes a design support apparatus 1 according to a first embodiment of the present invention.

### Design Support Apparatus 1

The design support apparatus 1 of the embodiment is an apparatus that includes a behavioral modification model M₁ for dynamically selecting a traveling guidance for a block user to accurately estimate a behavioral change of each block user, which is caused by a newly constructed commercial facility or the like in the block.

FIG. 1 is a schematic diagram of the design support apparatus 1 according to the embodiment. As illustrated in the drawing, the design support apparatus 1 includes an input device 2, a computing device 3, and an output device 4. The respective devices will be described in detail in order hereinafter.

### Input Device 2

The input device 2 is used by a designer of the bus operator or the like for inputting information into the computing device 3, and includes a behavioral purpose input unit 21 and a new facility information input unit 22. For example, the input device 2 may be a touch panel display, a keyboard, and the like.

### Behavioral Purpose Input Unit 2

The behavioral purpose input unit 21 is an input interface for setting the behavioral purposes with respect to all or a part of the block users on the simulator. The behavioral purpose may be such behavior as “purchase of a specific merchandise item”, “visit for outpatient care”, “commuting to office or school”, and the like.

If the behavioral purpose herein is to “purchase the specific merchandise item”, the block user's destination is highly likely to be dynamically changed depending on the traffic condition and the time zone. Meanwhile, if the behavioral purpose is to “visit for outpatient care” and to “commute to office or school”, the block user's destination is likely to be fixed irrespective of the traffic condition and the time zone.

Actually, on the premise of circumstances that there exist block users having the behavioral purposes of both types as described above, the designer inputs behavioral purposes of the block users on the simulator via the behavioral purpose input unit 21. Specifically, the designer inputs the behavioral purposes of a part of the block users on the simulator, which may dynamically change the destination (for example, “purchase of a specific merchandise item”), and further inputs the behavioral purposes of the remaining block users each having the fixed destination (for example, “visit for outpatient care” or “commuting to school”). The input behavioral purpose of each of the block users is output as behavioral purpose information I₁ to the computing device 3.

It is possible to incorporate a prompt function in the behavioral purpose input unit 21 for inputting characteristics of the block and the user to allow a generation unit 32 described later to automatically generate the behavioral modification model M₁ based on the prompt output.

### New Facility Information Input Unit 22

The new facility information input unit 22 is an input interface for setting a position and a characteristic of a facility to be newly constructed in the block (hereinafter referred to as a “new facility”) on the simulator. The new facility herein represents the facility that may possibly become a traveling destination of people and the vehicle, for example, the commercial facility, the residential area, and the like. A bus stop, a station, a parking area, and a transit point on the way to the traveling destination may be handled as the facility. The facility information input to the new facility information input unit 22 is output, as new facility information I₂, to the computing device 3.

### Computing Device 3

The computing device 3 is a general purpose computer including a computing unit such as a CPU, and a storage unit such as a RAM, and communicably connected to the input device 2 and the output device 4. A predetermined program is executed in collaboration with the computing device and the storage unit to implement the respective functions of a storage unit 31, the generation unit 32, a first computing unit 33, a second computing unit 34, an evaluation unit 35, and an adjustment unit 36, which are illustrated in FIG. 1. The respective function units will be described in detail in order hereinafter.

### storage Unit 31

The storage unit 31 is a function unit that holds environment information I₃ of the block, and service plan information I₄ including a traveling route R along which the service mobile object V travels in the block. The information data as described above are held in a database, or preliminarily set. The storage unit may be provided outside the computing device in the form of the cloud. The computing device may be provided with a memory for storing the information.

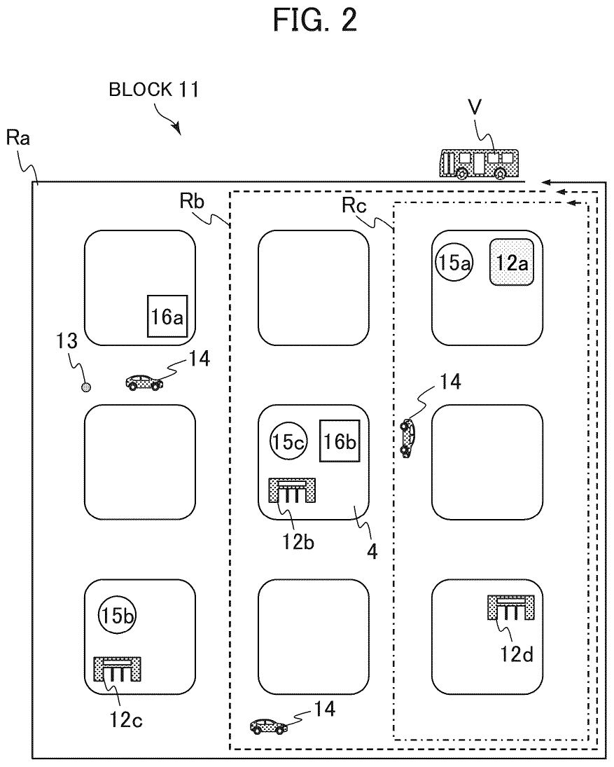

The environment information I₃ represents information of characteristics such as positions and sizes of a residential area 12a, stores 12b to 12d, and a road 13 in a block 11 as illustrated in FIG. 2. The environment information I₃ includes the information about the number of pedestrians (not shown) in the block 11, and the number of general vehicles 14 per unit road in the block 11. The environment information I₃ further includes information relating to bus stops 15a to 15c, station (not shown), and parking areas 16a, 16b. Additionally, the environment information I₃ includes information about merchandise items handled by the stores 12b to 12d, and the respective prices of those items. The above information data are registered by the designer.

The service plan information I₄ includes information about the vehicle model and the maximum capacity of the service mobile object V. The service plan information I₄ includes information about the traveling routes R (Ra to Rc), the timetable, and the fare table of the service mobile object V in the block 11 as illustrated in FIG. 2.

### Generation Unit 32

The generation unit 32 generates the behavioral modification model M₁ that modifies the behavior of the person in the block 11 using the behavioral purpose information I₁ and the environment information I₃.

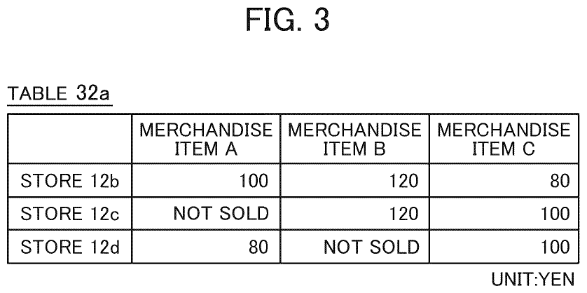

A table 32a is described with reference to FIG. 3. The table 32a is generated by the generation unit 32 based on the information contained in the environment information I₃ before generation of the behavioral modification model M₁. In an example illustrated in FIG. 3, the table 32a represents selling prices of merchandise items A to C sold at the stores 12b to 12d, which have been acquired from the environment information I₃. For example, the table 32a provides the information that the store 12b sells the merchandise item A at a selling price of 100 yen, the store 12c sells the merchandise item A at a selling price of 80 yen, and the store 12d does not sell the merchandise item A. The table 32a allows estimation that the block user who is going to purchase the merchandise item A is highly likely to select the store 12c as the destination.

Based on the behavioral purpose information I₁, the generation unit 32 appropriately sets the merchandise items A to C which are required by the block users (pedestrians or occupants of the general vehicle 14) each planning to “purchase the specific merchandise item” as the behavioral purpose.

The behavioral modification model M₁ generated by the generation unit 32 includes a formula 1 for calculating an evaluation value J for each block user. This formula is used for calculating the evaluation value J based on a price P selected from the table 32a concerning any of the merchandise items, a traveling distance L from a current position of the pedestrian or the general vehicle to the store, and an estimated traveling time Ta. The evaluation value J calculated by the formula 1 is an evaluation index, indicating that as the evaluation value becomes smaller, the evaluation becomes at a higher level. Meanwhile, as the evaluation value becomes larger, the evaluation becomes at a lower level.

$$J = {α}_{1} P + {α}_{2} L + {α}_{3} Ta \qquad ( formula 1 )$$

Each of terms α₁ to α₃ in the formula 1 denotes a weighting coefficient, and is set by the block user based on a behavioral priority that determines the traveling destination in accordance with the highest priority among the price P, the traveling distance L, and the estimated traveling time Ta.

### First Computing Unit 33

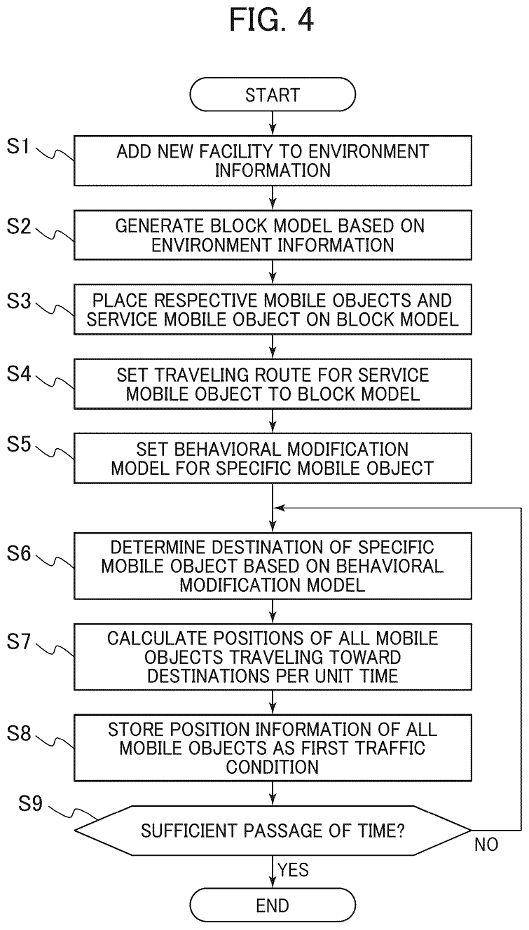

The first computing unit 33 outputs the traffic condition in the presence of the new facility on the simulator as a first traffic condition. The first computing unit 33 uses the new facility information I₂, the environment information I₃, the service plan information I₄, and the behavioral modification model M₁ to compute the first traffic condition. The following describes a method for calculating the first traffic condition by the first computing unit 33 in accordance with a flowchart of FIG. 4.

In step S1, the first computing unit 33 adds the new facility (for example, the store 12d) indicated by the acquired new facility information I₂ to the acquired environment information I₃.

In step S2, based on the environment information I₃ to which the new facility has been added, the first computing unit 33 generates a block model M₂ like the block 11 as illustrated in FIG. 2.

In step S3, the first computing unit 33 places the service mobile object V and other mobile objects (pedestrians, the general vehicle 14 and the like) on the block model M₂ generated in step S2.

In step S4, the first computing unit 33 sets the traveling routes Ra to Rc for the service mobile object V on the block model M₂ based on the traveling route R in the service plan information I₄ acquired from the storage unit 31.

In step S5, the first computing unit 33 sets the behavioral modification model M₁ for the specific mobile object (the pedestrian, the general vehicle 14, and the like).

In step S6, the first computing unit 33 determines traveling destinations for all the specific mobile objects based on the evaluation value J of the behavioral modification model M₁, which has been derived from the formula 1.

For example, if the purchase of the merchandise item A is set as the behavioral purpose of the specific mobile object, the stores 12b and 12d each selling the merchandize item A are set as the destination candidates based on the information of the table 32a (FIG. 3). Based on the information of the table 32a (FIG. 3), the first computing unit 33 extracts the selling prices of the merchandise items A at the respective stores, 100 yen and 80 yen, and calculates the traveling distance L and the estimated traveling time Ta to reach the traveling destination candidate from the current position of the specific mobile object, and position information of all the mobile objects existing in the block model M₂. The evaluation values J of all the stores as the traveling destination candidates are calculated by the formula 1. The store with the smallest evaluation value J is determined as the traveling destination. The determined traveling destination of the specific mobile object before registration of the new facility may possibly be changed after registration of the new facility.

In step S7, the first computing unit 33 calculates positions of all the mobile objects traveling toward the respective traveling destinations after an elapse of unit time (for example, 1 second). At this time, it is assumed that each mobile object autonomously selects the transportation that minimizes the traveling time to reach the traveling destination. For example, if there is no traffic congestion, the pedestrian selects the use of the service mobile object V (self-driving bus). Meanwhile, if the traffic congestion occurs, the use of the bus may delay the arrival time. Accordingly, the pedestrian selects walking to the destination. In the case of traveling by the general vehicle, the user parks the vehicle in the nearest parking area to the traveling destination, and then walks to the traveling destination.

In step S8, the first computing unit 33 stores the position information about all the mobile objects as the first traffic condition.

In step S9, the first computing unit 33 determines whether sufficient time has passed from start of processing. If passage of time is sufficient for the time required for evaluation, the process proceeds to end so that the computing operation of the first computing unit 33 is finished. Meanwhile, if passage of time is not sufficient for the time required for evaluation, the process returns to step S6. In this way, the traveling destination of the block user is updated, and the position information of all the mobile objects including the service mobile object V is calculated again to update the first traffic condition.

In the example as illustrated in FIG. 2 having three traveling routes R, the first computing unit 33 computes each of the first traffic conditions for the respective traveling routes R.

### Second Computing Unit 342

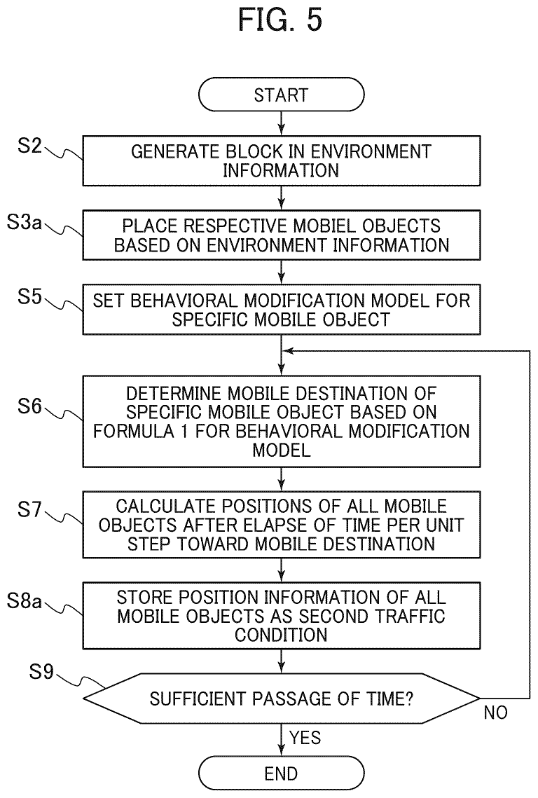

The second computing unit 34 outputs the traffic condition in the absence of the new facility on the simulator as a second traffic condition. The second computing unit 34 uses the environment information I₃ and the behavioral modification model M₁ to compute the second traffic condition. The following describes a method for calculating the second traffic condition by the second computing unit 34 in accordance with a flowchart of FIG. 5. Detailed descriptions of the similar processing to those of the flowchart in FIG. 4 will be omitted.

This flowchart is derived from omitting the step S1 for registering the new facility, and the step S4 for setting the traveling route for the service mobile object V, and replacing the steps S3, S8 in the flowchart of FIG. 4 with steps S3a, S8a, respectively. In step S8a, the second computing unit 34 executes process steps of the flowchart in FIG. 5 to calculate the second traffic condition as the traffic condition in the block where there are no operation of the service mobile object V nor the new facility.

### Evaluation Unit 35

The evaluation unit 35 evaluates comfort to the block user using the first traffic condition and the second traffic condition. For example, the method for evaluating improvement in the comfort attributable to introduction of the mobility service is implemented in accordance with the difference between the first and the second traffic conditions. In the case where the time at which the block user arrives at the destination in the first traffic condition (that is, when introducing the service mobile object V) is earlier than the arrival time in the second traffic condition, it is evaluated that the comfort is at a high level. Similarly, in the case where introduction of the service mobile object V lowers the congestion rate of the general vehicles in the block, it is evaluated that the comfort is at a high level. In the method for evaluating the comfort of the mobility service itself only from the first traffic condition, if the waiting time for the service mobile object V is shorter than a predetermined value, it is evaluated that the comfort is at a high level.

The evaluation unit 35 may be configured to evaluate the business feasibility of the service mobile object V using the first and the second traffic conditions. For example, assuming that the evaluation value calculation formula of the behavioral modification model M₁ generated by the generation unit 32 has an item concerning the fare of the service mobile object V, if the total amount of fares of the service mobile object V, which charges the pedestrian is more than the predetermined amount, it is evaluated that the business feasibility is at a high level. Those data are evaluation indexes correlated with one another. For example, if the congestion rate of the general vehicles is low, the waiting time for the service mobile object or the arrival time thereof may be shortened.

In the example of FIG. 2, the evaluation unit 35 evaluates the comfort and the business feasibility with respect to each of the plurality of traveling routes R.

### Adjustment Unit 36

The adjustment unit 36 adjusts each path of the traveling routes Ra to Rc which are preliminarily registered as the service plan information I₄ for improving the evaluation value J of the comfort or business feasibility. This allows the first computing unit 33 to re-calculate the first traffic conditions of the traveling routes Ra to Rc, respectively after adjustment. The evaluation unit 35 is allowed to re-evaluate the comfort and business feasibility with respect to the traveling routes Ra to Rc, respectively after the adjustment.

Repetitive execution of the processing as described above allows the design support apparatus 1 to specify the traveling route for the service mobile object V, which optimizes the evaluation index of the comfort or business feasibility while considering the behavioral modification of the block user in accordance with construction of the new facility.

### Output Device 4

The output device 4 is a device, such as a liquid crystal display, which is used by the designer for graphically confirming the processing result of the computing device 3. The output device 4 displays moving images of the service mobile object V that travels along the optimized traveling route R specified by the adjustment unit 36 of the computing device 3, and transitional positions of the general vehicle 14. The output device 4 may be configured to graphically display data calculated by the evaluation unit 35 of the computing device 3 for comparison between the index value of the comfort based on the first traffic condition and the index value of the comfort based on the second traffic condition.

### Advantageous Effect of the Embodiment

An advantageous effect of the embodiment according to the present invention will be described, taking the state illustrated in FIG. 2 as an example.

For example, it is assumed that the store 12b is set as the destination of a certain block user in the state where there are only stores 12b and 12c in the block 11. The generally employed art is not configured to set the behavioral purpose of each block user. Accordingly, even in the case of additionally registering the store 12d that sells the same merchandise item less expensive than the one sold by the store 12b, the destination of the block user will never be changed from the store 12b to 12d. The generally employed art cannot design the traveling route for the service mobile object V while considering modification of the block user's behavior in accordance with the newly constructed store 12d.

Meanwhile, according to the embodiment, the behavioral purpose of each block user is set. Even if the store 12b has been set as the destination of the block user, it is possible to autonomously change the destination to the store 12d that sells the less expensive merchandise item A in such a state of lighter traffic congestion in the block 11. The design support apparatus 1 of the embodiment makes the traffic flow in the block 11 more adaptable to actual circumstances.

When the service mobile object V is operated to travel along the traveling route Ra in the block 11, the pedestrian with the behavioral purpose makes a decision to use the service mobile object V in accordance with the degree of the traffic congestion on the road 13. As a result, it is possible to estimate the number of passengers and the sales of the service mobile object V. The behavioral modification model M₁ with the specific behavioral purpose allows the block user to dynamically select the transportation in accordance with the respective traffic conditions. It is therefore possible to accurately estimate the behavioral change of the block user in accordance with the newly constructed commercial facility in the block. This makes it possible to provide the design support apparatus that can preliminarily design the appropriate mobility service, and securely acquire more users of the mobility service.

As described above, the embodiment allows simulation of the traffic condition adaptable to actual circumstances by permitting the behavioral modification in accordance with the block user's behavioral purpose under the condition where the facility that satisfies the block user's behavioral purpose is newly constructed.

### Second Embodiment

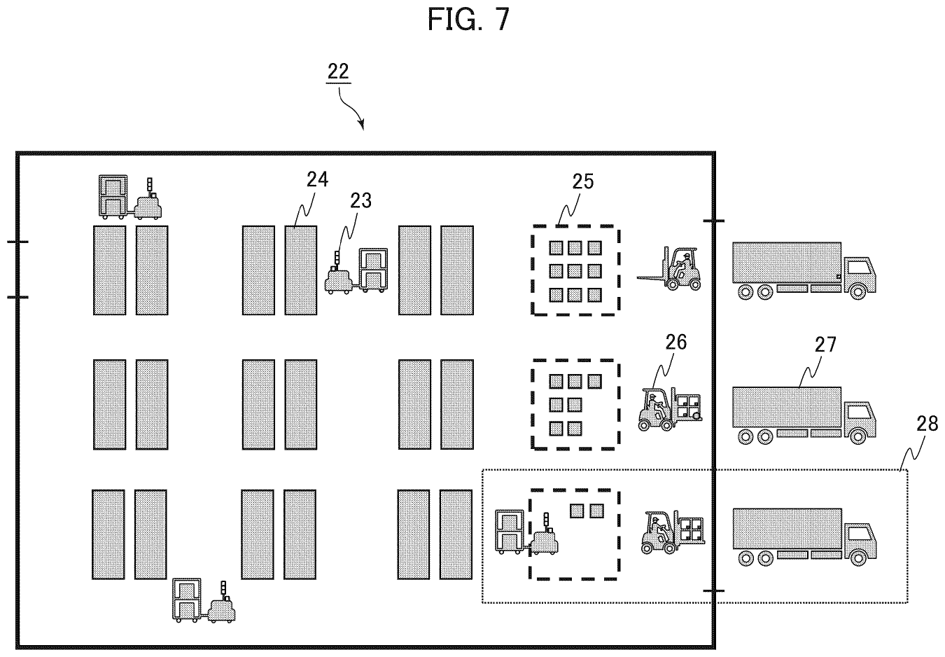

The following describes a design support apparatus 1 according to a second embodiment of the present invention with reference to FIG. 7. The repetitive descriptions common to those of the first embodiment will be omitted. The second embodiment is different from the first embodiment in that the behavioral purpose input unit of the input device is imparted with the function of inputting the behavioral purpose of the service mobile object, and the computing unit executes the processing in consideration of the behavioral purpose of the service mobile object.

Referring to an example of FIG. 7, a distribution warehouse 22 is exemplified as an operation service area of the mobility service, and an automatic transport vehicle 71 is exemplified as the service mobile object V. In this example, the automatic transport vehicle 71 picks up loads from a load shelf 24 in the distribution warehouse 22, and transports the loads to a load placing space 25. A forklift 26 transports the loads placed on the load placing space 25 appropriately from the load placing space 25 to a truck 75 for shipping.

Under the above-described circumstances, if construction of a new stopping place 28 for the truck is planned, the design support apparatus 1 of the embodiment evaluates improvement in the number of load shipments as a result of construction of the new stopping place 28. In this embodiment, maximization of the number of shipments is set as the behavioral purpose of the automatic transport vehicle 71 utilizing the behavioral modification model M₁ that autonomously determines the load placing space on which the load is placed by the automatic transport vehicle 71.

The generally employed art allows the automatic transport vehicle 23 to select the load placing space 25 based on the specific logic. In contrast, the embodiment can be configured to determine the effect of providing the load placing space 25 for maximizing the number of shipments using the behavioral modification model M₁ upon increase in the load placing spaces 25 for the new stopping place 28, while taking account of the interference with respect to the surrounding automatic transport vehicle. This makes it possible to provide the design support apparatus that allows preliminary designing of the traveling route for the automatic transport vehicle 23 to increase the number of shipments.

### LIST OF REFERENCE SIGNS

1: design support apparatus
2: input device
   21: behavioral purpose input unit
   22: new facility information input unit
3: computing device
   31: storage unit
   32: generation unit
   33: first computing unit
   34: second computing unit
   35: evaluation unit
   36: adjustment unit
4: output device
11: block
12a: residential area
12b to 12d: store
13: road
14: general vehicle
15a to 15c: bus stop
16a, 16b: parking area
V: service mobile object
Ra to Rc: traveling route

1. A design support apparatus for estimating a traffic condition in an area, comprising:
a storage unit that stores service plan information which contains a traveling route for a service mobile object, and environment information that contains an arrangement of a road and an object in the area;
a behavioral purpose input unit that inputs a behavioral purpose of a user in the area as behavioral purpose information;
a new facility information input unit that inputs a new facility in the area as new facility information;
a generation unit that generates a behavioral modification model that modifies a behavior of the user in the area using the environment information and the behavioral purpose information;
a first computing unit that computes a first traffic condition indicating the traffic conditions of the service mobile object and the respective users under an environment in which the service mobile object and the new facility exist using the service plan information, the environment information, the new facility information, and the behavioral modification model;
a second computing unit that computes a second traffic condition indicating the traffic conditions of the respective users under an environment in which the service mobile object and the new facility do not exist using the environment information and the behavioral modification model; and
an output device that outputs the first traffic condition and the second traffic condition,
wherein the first computing unit modifies the behavior of the user in accordance with an influence of the new facility, and computes the traffic conditions of the service mobile object and the respective users.

2. The design support apparatus according to claim 1, further comprising
an evaluation unit that evaluates comfort of the service mobile object using a difference between the first traffic condition and the second traffic condition.

3. The design support apparatus according to claim 2,
wherein if the difference indicates an early arrival time at the user's destination, or a congestion rate of the user is lowered, the evaluation unit evaluates that the comfort to the user has been improved.

4. The design support apparatus according to claim 1, further comprising an evaluation unit that evaluates comfort of the service mobile object using the first traffic condition.

5. The design support apparatus according to claim 4,
wherein in the first traffic condition, if a waiting time for the service mobile object is shorter than a predetermined value, the evaluation unit evaluates that the comfort to the user has been improved.

6. The design support apparatus according to any one of claim 2, further comprising
an adjustment unit that adjusts the traveling route contained in the service plan information.

7. A design support method for estimating a traffic condition in an area using a computer, the design support method comprising:
a behavioral purpose input step for inputting a behavioral purpose of a user in the area as behavioral purpose information;
a new facility information input step for inputting a new facility in the area as new facility information;
a generation step for generating a behavioral modification model that modifies the behavior of the user in the area using environment information containing an arrangement of a road and an object in the area, and the behavioral purpose information;
a first computing step for computing a first traffic condition indicating the traffic conditions of a service mobile object and the respective users under an environment in which the service mobile object and the new facility exist using service plan information containing a traveling route for the service mobile object, the environment information, the new facility information, and the behavioral modification model;
a second computing step for computing a second traffic condition indicating the traffic conditions of the respective users under an environment in which the service mobile object and the new facility do not exist using the environment information and the behavioral modification model; and
an output step for outputting the first traffic condition and the second traffic condition,
wherein the first computing step modifies the behavior of the user in accordance with an influence of the new facility, and computes the traffic conditions of the service mobile object and the respective users.
